(19) United States
(12) Patent Application Publication
(10) Pub. No.: US 2006/0159088 A1
(43) Pub. Date: Jul. 20, 2006

(54) Network mobility

(76) Inventors: Abdol Hamid Aghvami, London (GB); Paul Anthony Pangalos, London (GB); Andrej Mihailovic, London (GB)

Correspondence Address: KELLEY DRYE & WARREN LLP, TWO STAMFORD PLAZA, 281 TRESSER BOULEVARD, STAMFORD, CT, 06901, US

(21) Appl. No.: 11/332,036

(22) Filed: Jan. 13, 2006

(30) Foreign Application Priority Data
Jan. 14, 2005 (GB) 0500655.6

(51) Int. Cl. H04Q 7/24; H04L 12/56

(52) U.S. Cl. 370/389; 370/338

(57) ABSTRACT

A method of routing data packet flows from a mobile router in a mobile network, which mobile network comprises one or more network node attached to said mobile router, said mobile router for providing transparency at the network layer for said one or more network node to movement of said mobile network relative to a fixed network infrastructure, which method comprises the steps of: (a) receiving a data packet from a first host within said mobile network addressed to a second host; (b) estimating which type of traffic is present in said data packet; and (c) forwarding said data packet by applying a first routing method for a first type of traffic and a second routing method for a second type of traffic.

### CROSS-REFERENCE TO RELATED APPLICATIONS

Priority is claimed from UK Patent Application No. 0500655.6 filed Jan. 14, 2005 under 35 USC 119, the disclosure of which is incorporated herein in its entirety by reference.

All references cited in this specification, and their references, are incorporated by reference herein in their entirety where appropriate for teachings of additional or alternative details, features, and/or technical background.

### US GOVERNMENT RIGHTS

Not applicable.

### FIELD OF THE INVENTION

The present invention relates to a method of routing packet data flows from a mobile router in a mobile network, to a computer program, to a computer program product, to a mobile router, to a mobile network, to a mobile network comprising such as mobile router, to a vehicle comprising such a mobile router, and to a method of route optimising data packet flows from a mobile network.

### BACKGROUND TO THE INVENTION

Network mobility support is concerned with managing the mobility of an entire network, viewed as a single unit, which changes its point of attachment to a fixed or remote network infrastructure and thus its reachability in the network topology, most frequently the Internet. The mobile part of the network is referred to as a “mobile network”, that can be installed in a train for example, and which includes one or more “mobile routers” (MRs) which act as gateways to the mobile network and connect it to the global Internet. Internet access point on the train, Local Mobile Nodes (LMNs) such as mobile PDAs carried by personnel working on the train, and Visiting Mobile Nodes (VMNs) such as notebook computers and mobile telephones carried by passengers on the train. In most cases, the internal structure of the mobile network will in effect be relatively stable (no dynamic change of the topology), subject to joining and leaving of VMNs and LMNs. The MR provides wireless access for the network nodes via access routers that are part of the fixed network infrastructure. Access routers include satellites, UMTS Node Bs, GSM base stations, DVB transmitters and wireless access points.

The mobility of mobile networks does not cause the network nodes to change their own physical point of attachment, although they happen to change their topological location with respect to the global Internet. If network mobility is not explicitly supported by some mechanisms, the mobility of the MR results in mobile nodes losing Internet access and breaking ongoing connections with correspondent nodes (hereinafter CNs) in the global Internet. In addition, the communication path between the network nodes and the CNs becomes sub-optimal, and nested mobility will cause yet worse routing paths.

The current solution to provide network mobility is promoted by the NEtworks in MOtion (NEMO) working group of the Internet Engineering Task Force (see www.ietf.org/html.charters/nemo-charter.html). “NEMO Basic Support” (see RFC 3963 at the same website) aims to provide connection continuity for nodes in the mobile network, whilst optimization mechanisms will be provided in “NEMO Extended Support” of which there is an Internet Draft by Perera et al. (see below).

NEMO Basic Support provides connection (or session) continuity (e.g. continuity for TCP connections) by creating a “bi-directional tunnel” between the MR and its home network. This bi-directional tunnel is formed by encapsulating IP packets to and from the network nodes in IP packets addressed between the MR and a Home Agent on the MR's home network. In this way traffic flows are routed via the MR and its Home Agent and the mobility of the mobile network is transparent to all network nodes attached thereto. However, network nodes (particularly VMNs) can establish their own tunnels under Mobile IPv4 (MIPv4) and Mobile IPv6 (MIPv6) for example to their respective Home Agents and CNs. Thus each data packet flow between a network node in the mobile network and a CN passes through multiple tunnels before packets can be routed toward their destination as more fully described herein. This will result in high encapsulation overhead and routing delays, particularly at the MR's Home Agent since all traffic flows must be routed therethrough.

The Internet Draft “Route Optimization for Mobile Nodes based on Prefix Delegation” by Lee et al. (<draft-leekj-nemo-ro-pd-00.txt> presently available at www.ieft.org) provides route optimization by using a prefix delegation protocol. When a mobile router undergoes handover at the network layer it advertises the network prefix of its new access router in Router Advertisements, instead of advertising the network prefix of its home network as suggested by NEMO Basic Support. Mobile nodes behind the mobile router can then use the access router network prefix to auto configure a new primary care-of address that is topologically correct, which is notified to their respective Home Agents and any CNs in binding updates. In this way the Route Optimisation suggested in MIPv6 (RFC 3775) can be implemented for mobile nodes behind the mobile router, thereby mitigating the need for all traffic flows to be routed via the mobile node's Home Agent or the MR's Home Agent. One disadvantage of this method is the mobility of the mobile network becomes transparent to the network nodes behind the MR, in contravention of one of the aims set out in “Network Mobility Support Goals and Requirements” (<draft-ietf-nemo-requirements-02.txt>): each time the MR undergoes a network layer handover, all network nodes attached to the mobile network that have configured a topologically correct new care-of address will have to send binding updates. This results in high signalling overhead that should be avoided if possible, particularly in view of the limited radio resource on the wireless link between the MR and the access router.

The Internet Draft “Extended Network Mobility Support” by Perera et al. (<draft-perera-nemo-extended-00.txt> presently available at www.ietf.org) attempts to deal with these problems. Furthermore it aims to overcome the problem of indirect routing of datagrams to and from the mobile network via the NEMO bidirectional tunnel. The solution is to force the MR to act as an access router for the mobile nodes behind it. When it has moved to a new network, the MR advertises the new network prefix to mobile nodes attached to it. The mobile nodes can use the new network prefix to configure a topologically correct care-of address (e.g. by stateless address auto configuration) in a similar fashion to that described by Lee et al. In addition the mobile router acts as the Home Agent for LFNs and LMNs in the mobile network. The LFNs and LMNs send binding updates to the mobile router, acting as Home Agent, as usual under MIPv6. Since the LFNs and LMNs then have a Home Agent on the mobile network, it is not necessary for binding updates to be sent outside the mobile network (other than to CNs in Route Optimised mode) thereby reducing signalling overhead. Furthermore, all types of MIPv6 capable network nodes attached to the mobile network can use the MIPv6 Route Optimisation option to reduce routing packet delay, etc. associated with the NEMO bi-directional tunnel.

The solutions proposed by Lee et al. and Perera et al. enable MIPv6 Route Optimisation for network nodes behind the NEMO network with the benefits of reduced encapsulation overhead and routing delay. However, this is done at the expense of transport layer connection/transmission stability. In particular, ongoing connections will be broken when the MR undergoes a network layer handover.

Thus the proposals of Basic NEMO Support and the route optimisation proposal of Lee and Perera provide two different levels of connection stability for network nodes in the NEMO network: one provides connection stability through establishment of a NEMO bidirectional tunnel between the MR and its Home Agent, and the other provides route optimisation at the expense of a higher probability of connection breakage due to handovers of the MR.

From the foregoing it is apparent that there is a need for an improved method of providing data packet (or traffic) flow management for data packets passing through a mobile router in a mobile network which avoids routing all traffic through a bi-directional tunnel when possible, but which also does not expose transport layer connections to a high risk of interruption and thereby a lower quality of service for users.

### SUMMARY OF THE PRESENT INVENTION

Preferred embodiments of the present invention are based on the insight by the applicant that the same routing policy should not be applied to all data packet flows passing through a mobile router. In particular, the relative duration of different transport layer connections between hosts on the mobile network and hosts outside the mobile network can be used to select a routing method for each data packet flow. Based on this insight, traffic flow management can be enabled that reduces encapsulation overhead and the overall packet routing delay for nodes behind the mobile router and the remote hosts with which they correspond.

According to the present invention there is provided a method of routing data packet flows from a mobile router in a mobile network, which mobile network comprises one or more network node attached to said mobile router, said mobile router for providing transparency at the network layer for said one or more network node to movement of said mobile network relative to a remote network infrastructure, which method comprises the steps of:

(a) receiving a data packet from a first host within said mobile network addressed to a second host; (b) estimating which type of traffic is present in said data packet; and (c) forwarding said data packet to said fixed network infrastructure by applying a first routing method for a first type of traffic and a second routing method for a second type of traffic. A packet data flow may be defined as a flow of data packets generated by one application running on a host in the mobile network. Thus each packet data flow is associated with one application of one user. One advantage of this method is that data packet flows can be differentiated on the basis of expected transport layer connection duration and routed by an appropriate routing method. For example, shorter duration connections can be routed by a first routing method that has a relatively high probability of connection interruption per unit time compared to a second routing method that has a lower probability per unit time. A connection interruption may occur when the mobile router undergoes a network layer handover. Another advantage is that no new hardware or software functionality is required other than in a mobile router. Therefore reduction in routing delays and encapsulation overhead can be obtained with a software update of a mobile router for example. Preferably, the second host is not part of the mobile network but is reachable via an external network such as the Internet or WAN. In one aspect step (c) may comprise the step of forwarding said data packet to an access point (e.g. base station, satellite, relay station, access router) of the remote network infrastructure. The forwarding may be direct (e.g. in one hop) or indirect (e.g. in two or more hops), for example via other mobile routers or relay stations. Remote network infrastructure may mean any equipment that is physically distant from the mobile router and that is operated by the network operator rather than by the user. As such this network infrastructure enables multi-mode mobile terminals to communicate with one another and with the network operator. Often such equipment is fixed in a permanent or temporary physical location. For example remote network infrastructure includes, but is not limited to, base stations, satellites, transmitters, receivers and relay stations.

A data packet may be defined as a piece of an electronic message that is transmitted over a packet-switched network such as the Internet. Traffic may be differentiated into types by a large number of different variables, for example by application, by user of the application (represented by a network interface address for example), by Quality of Service flags in the data packet header, by source address in the data packet header, etc. However, it is advantageous if expected connection or transmission duration is used as the primary differentiator between traffic types. In the present context “connection” may mean the time taken by the transport layer protocol in the first host to establish a connection with the second host, receive all of the data from the second host that is requested and to close the connection. “Transmission” may mean the time taken for the first host to forward all of the data packets toward the second host, which therefore may be shorter than the corresponding connection time. Routing method may mean a way of forwarding the data packet from the mobile network such as by IP-in-IP tunnelling.

Preferably, said first type of traffic comprises data generated by an application that typically requires a shorter duration of transport layer activity, for example connection or transmission, than said second type of traffic. For example, the application may be a Web-browsing application and an e-mail application.

Advantageously, said duration of transport layer activity is defined with reference to a duration between network layer handovers of said mobile router, whereby said data packet is routed by said first routing method if said transport layer activity is expected to last less than said duration between network layer handovers or by said second routing method if said transport layer activity is expected to last longer than said duration between network layer handovers. In one embodiment the mobile router may monitor and record times between network layer handover and update the routing policy accordingly. Thus the mobile router may respond dynamically to frequency of network layer handover.

Preferably, the method further comprises the step of monitoring types of traffic flows through said mobile router and implementing said first and/or second routing methods depending on the relative proportions thereof. This helps to increase quality of service for all users attached to the mobile router.

Advantageously, the method further comprises the step of selecting said first or second routing method based on a source network layer address in said data packet, whereby different users on said mobile network may be offered different levels of quality of service. Use of the source network layer address provides a means to differentiate between users based on information already present in each data packet flow.

Preferably, the method further comprises the steps of storing a routing database in a memory of said mobile router, which routing database comprises a mapping between said first traffic type and said first routing method, and a mapping between said second traffic type and said second routing method, and searching said routing database when said traffic type has been estimated to determine the routing policy for said data packet.

Advantageously, said first type of traffic comprises data generated by use of a Web browsing application, an e-mail application, a short FTP application and/or a peer-to-peer application for example. These applications generally generate transport layer connections or transmissions of shorter duration and therefore less sensitive to network layer handovers. It will be appreciated, however, that in one embodiment, a short-lived application is defined according to the frequency of network layer handover such that, depending on where the invention is implemented, traffic from applications may be classified either as said first or second types.

Preferably, said second type of traffic comprises data generated by use of a File Transfer Protocol application, a Voice over IP application and/or a streaming application for example. These applications generally generate transport layer connections or transmissions of longer duration and therefore more sensitive to network layer handovers.

Advantageously, said first routing method comprises a route optimized method in which said data packet can be sent toward said second host directly from the network to which the mobile router is attached. This helps to avoid the encapsulation overhead of a bi-directional tunnel, such as a NEMO bi-directional tunnel between the mobile router and its home agent.

Preferably, said first routing method comprises the steps of replacing a source address of said data packet with a network layer address of an interface within a foreign network to which said mobile router is attached, whereby said data packet may be routed directly from said foreign network toward said second host. This has the advantage that the second host will address packets to the interface in the foreign network, avoiding the need for routing via the mobile router's home agent.

In one embodiment said network layer address is different for each traffic flow passing through said mobile router. For example IP packets in each traffic flow may have their source address replaced with a respective topologically correct IP address on the foreign network to which the mobile router is attached. The mobile router would then store a mapping between the each host's actual IP address and the assigned IP address. The second host would then address packets to the topologically correct that IP addresses, unaware that the actual IP address of the first host is different. On receipt, the mobile router would replace the topologically correct destination IP address of each packet with the actual IP address of the first host using the mapping stored in memory and send the packets on toward the first host.

In another embodiment said network layer address is the same for all traffic flows passing through said mobile router. Traffic flows may be differentiated on the basis of some means other than a topologically correct IP address on the foreign network to which the mobile router is attached. The means may be a destination port number in a header of a transport layer segment for example.

Advantageously, the method further comprises the step of storing in electronic memory a unique identifier for each data packet flow, such that a return data packet flow sent from said second host in reply to said first host comprises said unique identifier, whereby said mobile router may forward said return data packet flow over the correct link toward said first host on said mobile network.

Preferably, the method further comprises the step of replacing an identifier of said traffic type in said data packet with said unique identifier.

Advantageously, the method further comprises the step of storing a binding database in said electronic memory, which binding database comprises a mapping between an identity of said first host and said unique identifier, whereby data packets from said second host may be routed toward said first host.

Preferably, said unique identifier comprises an arbitrarily assigned port number that has not already been assigned to another data packet flow passing through said mobile router. The port number may be a TCP source port number for example.

Advantageously, step (b) comprises the step of examining said data packet for a traffic type identifier to identify said type of traffic carried therein.

Preferably, the method further comprises the step of examining a transport layer segment carried by said data packet to determine said type of traffic.

Advantageously, said traffic type identifier comprises a destination port number in a header of said transport layer segment, the method further comprising the step of using said destination port number to determine whether or not said data packet carries traffic of said first or second types.

Preferably, said header comprises a Transmission Control Protocol (TCP) or User Datagram Protocol (UDP) header.

Advantageously, said second routing method comprises the step of indirectly routing said data packet from said mobile router toward said second host, in which mobility of said mobile router at the network layer is substantially transparent to said first host. In this way packet flows that typically require a longer duration of transport layer connection/transmission can be protected from network layer handovers. This may be using a NEMO bi-directional tunnel for example.

A method according to any preceding claim, further comprising the step of monitoring the status of network layer handover of said mobile router and implementing a third routing method if and when said mobile router detects or is undergoing network layer handover between access routers. The third routing method helps to maintain of quality of service for users. The handover may be detected by a layer 3 trigger such as a Neighbour Unreachability Detection, or a layer 2 trigger such as a change in MAC address of the wireless interface of the access router to which the mobile router is attached.

Preferably, said third routing method comprises the step of inspecting said data packet for an indication that said first host is attempting to establish a transport layer connection with or has just begun data transmission to said second host. Such an indication might be provided by a TCP segment with the SYN flag set for example.

Advantageously, if said indication is present the method further comprises the steps of replacing a source address of said data packet with an address of an interface within a new foreign network to which said mobile router is to be handed over, whereby said data packet may be routed directly from said new foreign network toward said second host.

Preferably, the method further comprises the step of maintaining existing transport layer connections that are routed by said first routing method via the old foreign network during said handover.

Advantageously, said data packet comprises an IPv4 datagram or an IPv6 datagram.

Preferably, said mobile network operates under a NEMO, NEMO-like or NEMO-derived protocol.

According to another aspect of the present invention there is provided a computer program comprising computer executable instructions for causing a mobile network to perform the method steps set out above.

According to another aspect of the present invention there is provided a computer program comprising computer executable instructions for causing a mobile router to perform the method steps set out above. The computer executable instructions may be downloaded from the network infrastructure to a mobile router in the form of a software upgrade. Alternatively they may be installed at point of manufacture.

According to another aspect of the present invention there is provided a computer program product storing computer executable instructions in accordance with those mentioned above. The product may be useable to upgrade one or more mobile router.

The computer program product may be embodied on a record medium, in a computer memory, in a read-only memory or on an electrical carrier signal.

According to another aspect of the present invention there is provided a mobile router comprising an electronic memory storing computer executable instructions that when executed cause the mobile router to perform the method steps as set out above.

According to yet another aspect of the present invention there is provided a mobile network comprising a mobile router as aforesaid. There a wide range of mobile networks and potential mobile networks; reference is made to the examples given herein.

In one embodiment there is provided a vehicle comprising a mobile router as aforesaid. It will be appreciated that the number of vehicles where the invention is applicable is wide-ranging; for example: boats, planes, trains, cars, buses, coaches, lorries, military vehicles and construction vehicles.

Preferred embodiments of the present invention also provide an alternative route optimising method in which mobility of the mobile network is transparent to the network nodes in the mobile network that results in lower signalling and encapsulation overhead

According to another aspect of the present invention there is provided a method of route optimising data packet flows from a mobile router, which method comprises the steps of:

(a) receiving a data packet from a first host within said mobile network addressed to a second host;

(b) replacing a source address in said packet with a topologically correct address on a foreign network to which said mobile router is presently attached; and

(c) forwarding said packet toward said second host;

whereby data packets sent by said second host in reply will be addressed to said topologically correct address on said foreign network. This reduces the encapsulation overhead associated with a NEMO bi-directional tunnel. In one aspect this route optimising is performed on those packet flows that are less sensitive to network layer handovers i.e. those that have relatively short transport layer connection/transmission duration, such as Web-browsing and e-mail applications. In this way the route optimising is dynamic i.e. it is not applied to all packet flows from one user, and may only be applied from time to time as needed for example. The mobile router may monitor network layer handover frequency and take a decision whether or not to use this optimising method based on a typical duration between network layer handovers. Advantageously, said source address is a public (i.e. routable) IP address and said topologically correct address is a public IP address.

### BRIEF DESCRIPTION OF THE DRAWING

For a better understanding of how the invention may be put into practice, a preferred embodiment of the invention implemented on a train will be described, by way of example only, to the accompanying drawings, in which:

FIG. 1 is schematic block diagram of a wireless network environment with a mobile network in accordance with the present invention passing therethrough;

FIGS. 2 and 3 are schematic representations of the tunnels established between various network nodes in FIG. 1 when operating under NEMO Basic Support and MIPv6;

FIG. 4 is a schematic representation of the IP-in-IP encapsulation of data by the tunnels and FIGS. 2 and 3;

FIGS. 5 and 6 are schematic representations of the tunnel established between various network nodes in FIG. 1 when operating under NEMO Basic Support and MIPv6 Route Optimised mode;

FIG. 7 is a schematic representation of the IP-in-IP encapsulation of data by the tunnel and FIGS. 5 and 6;

FIG. 8 is a schematic block diagram of a mobile router in accordance with the present invention;

FIG. 9 is a schematic block diagram of software modules of the present invention that are stored and operated by the mobile router of FIG. 8;

FIG. 10 is a generic policy table in accordance with the present invention;

FIG. 11 is a policy table in accordance with the present invention;

FIG. 12 is a schematic block diagram of a traffic flow management method in accordance with the present invention;

FIG. 13 is a flowchart of the traffic flow management method of FIG. 12; and

FIG. 14 is a schematic block diagram of a mobile router handover method according to the present invention.

### DETAILED DESCRIPTION OF THE PREFERRED EMBODIMENT

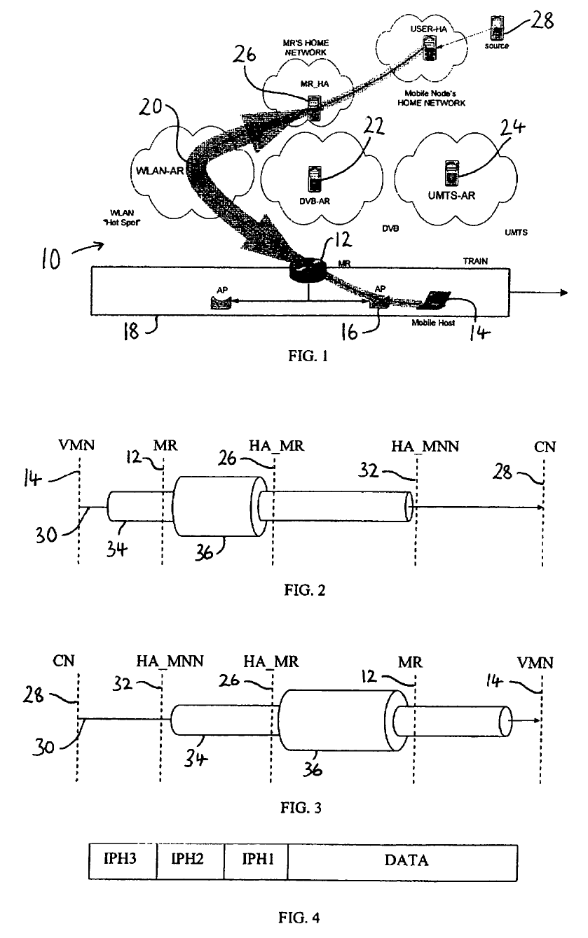

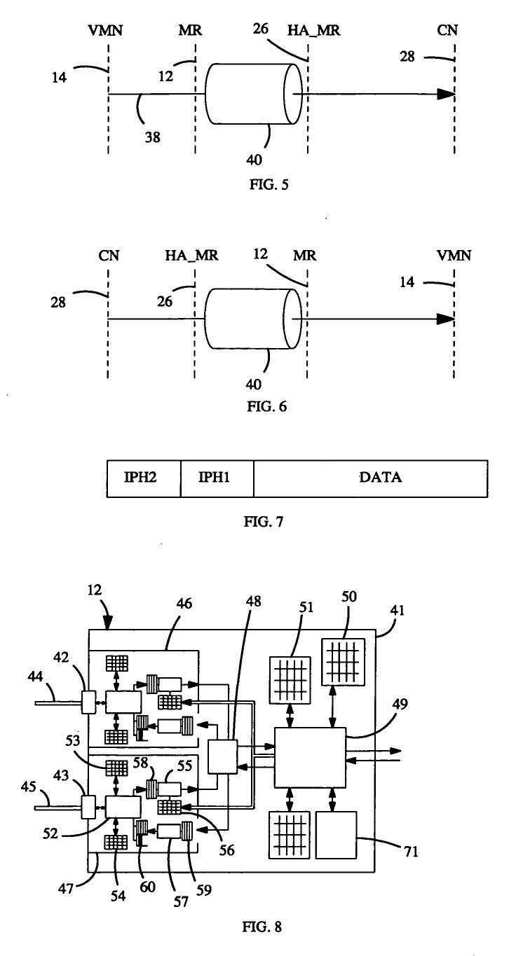

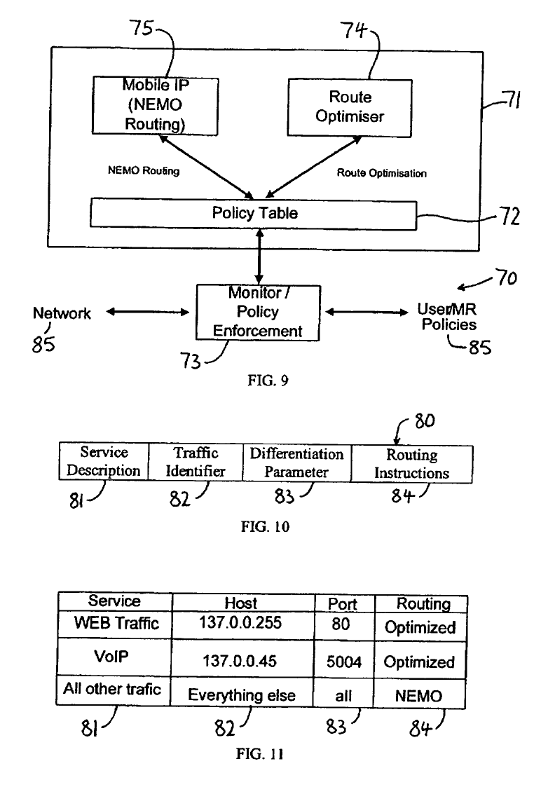

Referring to FIG. 1 a mobile network generally identified by reference numeral 10 comprises a mobile router (MR) 12, serving a Visiting Mobile Node (VMN) 14 (that is multi-mode) via an access point (AP) 16. The AP 16 may be a wireless access point or a wired access point. The mobile network 10 is part of a train 18 that moves relative to a remote network infrastructure comprising a number of physically fixed access routers 20, 22 and 24 that are not part of the train 18: access router 20 operates under a wireless local area network (WLAN) communication protocol such as IEEE802.11; access router 22 is a Digital Video Broadcast (DVB) access router operating under a DVB transmission protocol; and access router 24 is a Universal Mobile Telecommunication System (UMTS) access router operating under a UMTS communication protocol, or other IMT-2000 communication protocol. Each of the access routers 20, 22 and 24 provides wireless access for the MR 12 and the VMN 14 to a fixed packet-switched network, such as the Internet, so that the VMN 14 can send and receive packet data from the train, both whilst moving and stationary. The MR 12 has an ingress interface for receiving IP packets from and transmitting IP packets to network nodes in the mobile network 10, and an egress interface for receiving IP packets from and transmitting IP packets to the fixed packet-switched network. As explained above, one of the aims of the NEMO Basic Support is to ensure that the motion of the train 18 is transparent to any network nodes (LFN, LMN and/or VMN) behind the MR 12. Motion of the train past the access routers 20, 22, 24 necessitates network layer handover of service from one access router to another. Since the MR 12 connects an entire network to remote packet networks, each change in point of attachment (i.e. change in access router) to the remote packet networks causes the reachability of the entire mobile network 10 to change. Without appropriate mechanisms, connections established between nodes in the mobile network 10 and nodes in the remote packet networks cannot be maintained across each handover. Connection continuity is primarily achieved in NEMO Basic Support through establishment of a bidirectional tunnel (herein NEMOBT) between the MR 12 and a Home Agent (HA_MR) 26 of the MR 12. Aspects of the operation of the NEMOBT relevant to the present invention will be briefly described below. Further details can be found in “Basic Network Mobility Support”, Wakikawa, R et al. (draft-wakikawa-nemo-basic-00.txt) and “Network Mobility (NEMO) Basic Support Protocol” Devarapalli, V. et al., both presently available at www.ietf.org/html.charters/nemo-charter.html.

The Mobile Internet Protocol (Mobile IP) was designed specifically to handle the routing of IP data packets to and/or from mobile nodes (i.e. mobile terminals that frequently change their point of attachment to the Internet. Moreover, Mobile IP was designed to handle the routing of IP data packets to and/or from mobile nodes without significantly interrupting on-going communications and without requiring mobile nodes to restart applications. Presently there are two versions of Mobile IP that have been proposed by the Internet Engineering Taskforce (IETF): Mobile IPv4 and Mobile IPv6. One of the common features between the two protocols is that an interface on each mobile node has (1) a “home address” i.e. a permanent IP address for an interface associated with the mobile node's point of attachment to the Internet at its home network, and (2) a “care-of address” i.e. a temporary IP address that is assigned to the interface when the mobile node attaches to a foreign network. Whenever a mobile node (e.g. the VMN 14) attaches to a foreign network it sends a “binding update” to a special agent called a “Home Agent” (herein HA_VMN) on the home network. The HA_VMN maintains a binding database that maps the VMN's home address to the latest care-of address. IP data packets arriving at the HA_VMN are encapsulated in another IP header and sent to the care-of address where the VMN decapsulates the packet to reveal the original IP packet from the CN addressed to the VMN's home address. A similar process happens for packets from the mobile node addressed to the CN. This process is known as “bidirectional tunnelling” (herein MIPBT) between the mobile node and Home Agent. Mobile IPv6 adds some extra functionality over Mobile IPv4. In particular, each VMN sends the binding updates to the HA_VMN and each CN. In this way, each CN can send IP packets directly to the care-of address of the VMN and vice versa, whereby the use of the MIPBT is mitigated. This is known as Route Optimisation.

If the MR 12 is at its home network the prefix advertised over the ingress interface matches the prefix of the egress interface of the MR 12. Accordingly, when a VMN 14 moves into the area served by the MR 12 and AP 16 the newly configured care-of address is topologically correct i.e. IP packets addressed to the care-of address configured using the prefix of the ingress interface will be routed correctly and reach the egress interface of the MR 12 where they are routed to the VMN 14. However, when the mobile network 10 moves away from its home network (for example the station where the train 18 commences its journey), the care-of address configured by the VMNs from the ingress interface of the MR 12 is no longer topologically correct and IP packets sent by CNs will not reach their destination.

The NEMO standard deals with this problem by establishment of a NEMOBT between the MR 12 and a HA_MR 26, and specifies that all incoming and outgoing IP traffic should be routed via this NEMOBT. It is to be noted that the NEMOBT separate and distinct from any MIPBT used under Mobile IP.

Thus from the point of view of the mobile network 10, there are two scenarios to consider (assuming all nodes are Mobile IPv6 capable):

(1) the VMN 14 moves within range of the AP 16 during a TCP connection with one or more CNs; and

(2) the VMN 14 is brought into range of the AP 16 whilst not running a TCP connection.

Within each scenario there is two further possibilities:

(a) the VMN 14 is communicating (or will communicate) with a CN using a MIPBT (for example if the CN is only MIPv4 enabled or if the Return Routability test has failed); and

(b) the VMN 14 is communicating (or will communicate) directly with the CN in the MIPv6 Route Optimised mode.

In scenario (1)(a) and (1)(b) TCP connection continuity is maintained as described in Mobile IPv6. Briefly, the VMN 14 configures a new care-of address based on the network prefix advertised by the ingress interface of the MR 12 (this is the MR home network prefix assigned by the home network of the MR and is a static IP address). In (1)(a) the VMN 14 then sends binding updates to the HA_VMN and to the CN using a MIPBT. The HA_VMN will forward packets to the home network of the MR 12 and vice versa, and the home network of the MR will forward packets to the MR 12 using the NEMOBT. In (1)(b) the VMN 14 will send a binding update to the CN using a MIPBT and the NEMOBT. These tunnels will also be used for the Return Routability test. Once the correspondent host has tested the new care-of address it will send packets to the VMN 14 in the Route Optimised mode. Packets will be addressed to the MR's home network (instead of the HA₁₃ VMN) and then tunnelled to the MR using the NEMOBT. Packets from the VMN 14 will be sent to the CN via the NEMOBT but not via the HA_VMN since the new care-of address is topologically correct for the home network of the MR. All subsequent changes in point of attachment of the MR 12 will be transparent to the VMN 14 due to use of the NEMOBT.

If the MR 12 has the capability described in the Lee or Perera Internet Drafts, it will advertise the new network prefix and the VMN 14 will be able to configure a care-of address that is topologically correct for the MR's new point of attachment to the global Internet. In that case, if the VMN 14 has an ongoing TCP connection when it attaches to the MR 12, binding updates and the Return Routability test can be performed as per MIPv6 i.e. using a MIPBT. After this, the VMN 14 can communicate with CNs either indirectly using a MIPBT (i.e. via the HA₁₃ VMN) or directly in the Route Optimised mode. In both cases, use of the NEMOBT is mitigated since the care-of address of the VMN 14 is topologically correct for its present point of attachment to the network.

In scenario (2), assuming that the MR 12 advertises the network prefix of its home network as suggested by NEMO Basic Support, the VMN 14 configures a new care-of address and performs a binding update with the HA_VMN before initialising a TCP connection with the CN. The communication may be performed under (a) or (b) above depending on whether the CN is MIPv6 enabled and if the Return Routability test is successful. However, in both cases use of the NEMOBT is required since the care-of address is defined on the basis of the network prefix of the home network of the MR 12.

If the MR 12 has the capability in the Lee or Perera Internet drafts, it will advertise the new network prefix and the VMN 14 will be able to configure a care-of address that is topologically correct for the MR's new point of attachment to the network. The VMN 14 can then perform binding updates with the HA_VMN and any CNs in its binding cache. Should a TCP connection need to be established the VMN 14 can use the new care-of address as the source address in IP packets and correspond either using a MIPBT or in the Mobile IP Route Optimised mode. In both cases the need to use the NEMOBT is mitigated.

The MIPBT and NEMOBT are illustrated in FIGS. 2 to 7. In FIGS. 2 and 3 scenario (1)(a) and (2)(a) is shown. In particular, a TCP connection is under way and the VMN 14 has addressed a data packet with IP header IPH1 (FIG. 4) from its home network address to the CN 28 IP address. This addressing is represented by line 30. According to Mobile IPv6 in this scenario, the VMN 14 encapsulates the first IP packet with a new IP header IPH2 addressed to the HA_VMN 32 from its present care-of address (i.e. that configured from the prefix advertised by the ingress interface of the MR 12). This establishes a MIPBT 34. The VMN 14 then transmits the encapsulated packet to the MR 12. Upon receipt of the IP packet the MR 12 encapsulates the packet with a further IP header IPH3 addressed to the HA_MR 26 from the MR 12 to establish a NEMOBT 36. Thus the original IP data packet has been encapsulated two further times. When the IP packet reaches the HA_MR 26, it is decapsulated (represented by the end of the NEMOBT 36) to reveal the IP packet IPH2 addressed to the HA_VMN 32 and is forwarded accordingly. When that IP packet reaches the HA_VMN 32 it is decapsulated (represented by the end of the MIPBT 34) to reveal the IP packet IPH1 addressed to the CN and is forwarded accordingly. It will be appreciated that the extra encapsulation required by the NEMO standard in the form of the NEMOBT will result in high encapsulation overhead and latency since all traffic must by routed via the HA_MR 26 and via the HA_VMN 32. FIG. 3 shows the Mobile IP and NEMO tunnels when IP packets are sent from the CN 28 to the VMN 14. It is also necessary for all traffic to be routed via the HA_MR 26 in this direction.

Referring to FIGS. 5 to 7 scenario (1)(b) and (2)(b) is illustrated. The VMN 14 has initialised one or more TCP connection (after having moved into the area covered by AP 16) with the CN 28 and the Return Routability Test has been successful, thereby mitigating the need for a MIPBT and permitting the VMN 14 and CN 28 to communicate in the MIPv6 Route Optimised mode. The VMN 14 addresses packets to the CN 28 with a source address indicating the care-of address configured by the VMN 14 in the IP header IPH1 (FIG. 7). The line 38 indicates this addressing. Upon receiving the IP packet the MR 12 encapsulates it with another IP header IPH2 addressed to the HA_MR 26. This establishes a NEMOBT 40. When the HA_MR 26 receives the IP packet it is decapsulated to reveal the first IP header IPH1 addressed to the CN 28 and is forwarded accordingly. FIG. 5 shows the NEMOBT when IP packets are sent from the CN 28 to the VMN 14. In both cases it is necessary for all traffic to be routed via the MR 12 and HA_MR 26. Although routing via the HA_VMN 32 is avoided there is still a relatively high encapsulation overhead and routing latency.

Although the proposals by Lee et al. and Perera et al. mitigate the use of a NEMOBT and permit network nodes behind the MR 12 to be routed more efficiently to CNs, no consideration has been given to how data packet flows through a MR might be handled to achieve good throughput and reduced congestion delay. In particular, the applicant has realised that by managing the data packet flows and not applying the same routing policy to all data packet flows, overall performance can be enhanced and routing delays reduced.

FIG. 8 shows the mobile router 12 that comprises a case 41 having network interface ports 42 and 43 to which respective cables 44 and 45 provide a physical link to respective IP networks. Two network interface cards 46 and 47 are connected to their respective network interface ports 42 and 43 and form the ingress interface and egress interface respectively. A hardware packet switch 48 connects the network interface cards 46, 47 and a central processing unit (CPU) 49 can communicate with a routing table 50 and router management tables 51.

Each network interface card 46, 47 comprises a link layer protocol controller 52 that has access to an interface management table 53 and a hardware address table 54 (e.g. Address Resolution Protocol cache). In communication with the link protocol controller 52 is a network protocol-forwarding engine 55 having access to a forwarding table 56 (route cache), and an interface queue manager 57. Both the network protocol forwarding engine 55 and interface queue manager 57 have an interface to and from the packet switch 48 respectively.

In use, frames are received by the link layer protocol controller 52 that handles the link layer protocol (e.g. HDLC, Ethernet) used over the physical link. Frame integrity is checked and valid frames are converted into data packets (e.g. IP packets) by removing the link layer header and, if necessary, the data packets are queued in a queue 58. Storage capacity is often in the form of a ring of memory buffers. One data packet at a time is removed from the queue 58 by the network protocol-forwarding engine 55 and the forwarding table 56 determines whether or not the packet requires detailed examination by the CPU 49. Via the CPU 49 the next router to which the packet should be sent is looked up in the routing table 50. If the IP packet arrived on the ingress interface (i.e. from the mobile network 10) the CPU 49 instructs encapsulation of the IP packet with an IP header addressed to the HA_MR, in order to reverse tunnel the packet over a NEMOBT as described above. If the packet has been received on the egress interface (i.e. from the access router over the wireless link) the CPU 49 instructs decapsulation of the IP packet to reveal an IP header addressed to a care-of address valid on the ingress interface as described above. Once the destination IP address is found the CPU 49 searches the ARP cache for a Media Access Control (MAC) address for that destination. The CPU 49 now knows where to send the packet and the new link layer header to use. The link layer address is added and the packet is linked into the list of frames to be sent on from the appropriate network interface card. The packet is then forwarded to the packet switch 48 and onto the network interface card where the packet joins a queue 59 to be processed by the interface queue manager 57. From here the packet joins one of a number of link output queues 60 until the link layer protocol controller 52 can process it. The link layer protocol controller 52 encapsulates the packet in a link layer header that includes the Media Access Control (MAC) address of the next router to which the packet is to be sent. The MAC address is obtained from the hardware address table 54. The packet is then placed on the physical channel by the link layer protocol controller 52.

Various types of mobile router are available and the present invention is not limited to that described above. Further examples are available from Cisco Systems, Inc. (www.cisco.com) for example.

Referring also to FIG. 9 an electronic memory 71 (for example hard disk (e.g. solid state or magnetic disk), Random Access Memory (RAM), Read Only Memory (ROM)) stores computer executable instructions that when executed by the CPU 49 bring about a traffic flow controller 70 in the MR 12 that comprises a “Policy Table” (PT) 72, “Monitor/Policy Enforcer” (MPE) 73, “Route Optimiser” (RO) 74 and “NEMO Routing” (NR) 75. These logical entities co-operate to improve traffic flow control in the MR 12, for example by reducing the round trip time of IP packets sent between the VMN 14 and the CN 28 and vice versa.

The traffic flow controller 70 provides an intelligent routing function for traffic originating behind the MR 12 by selecting a routing method for each data packet flow based on rules set out in the PT 72. When traffic type is used as the basis of selecting the routing method, overall performance is enhanced as encapsulation overhead and routing delay are reduced. In particular, the standard NEMO routing option provides stable connectivity at the expense of increased encapsulation overhead and end-to-end packet delays. Therefore it is suitable for relatively long-lived TCP connections that must survive layer 3 (i.e. network layer) handovers of the MR 12, such as FTP. In contrast the route optimised method described herein (and those of Lee et al. and Perera et al.) provides lower end-to-end packet delay and reduced encapsulation overhead at the expense of less stable connectivity. Therefore the route optimised routing method is most suitable for relatively short-lived TCP connections, by which is meant those connections that have duration less than the time between handover of the MR 12 from one access router to another; in contrast the NEMOBT routing method is more suitable for those TCP connections that need to survive network layer handover. The PT 72 enables the traffic flow controller 70 to select different routing methods according to the TCP connection sensitivity as defined by the rules imposed by the MPE 73. In this way, the benefits of both routing methods are combined to improve the overall performance of the MR 12. In particular, since a portion of the traffic that would have been routed by the standard NEMOBT is routed by the route optimised method, the performance of the NEMOBT is expected to improve as a result of smaller traffic volume and less congestion and processing delays.

Short-lived TCP connections include both persistent (either with pipelining or without pipelining) and non-persistent TCP connections, such as Web browsing using HTTP, VoIP, etc. Such short-lived TCP connections tend to be burst-like in nature e.g. when a user opens a Web page TCP undergoes a short period of activity (typically between 1s and 30s) until all objects are loaded and displayed to the user. There then is often a period of TCP inactivity whilst the user digests the content of the Web page before selecting a further link, followed by more short-lived TCP activity, or closes the Web browsing application. This is in contrast to applications that generate comparatively long TCP connections, such as those that use FTP and streaming, where data is sent continuously over a period of about 30s or more. Because the care-of address used as the source address of each IP packet is only topologically correct for the particular foreign network to which the MR 12 is presently attached, route optimisation cannot survive handover at layer 3 i.e. the network layer. It will be appreciated that the time between handovers may vary considerably depending on where the mobile network is installed. For example, if the mobile network 10 is installed in a plane, the time between access router handovers may be of the order of several hours since the access routers are likely to be satellites with large areas of coverage. However, if the mobile network 10 is installed in a train, bus or car for example, the time between access router handovers may be of the order of tens of minutes or a number of hours depending on the speed and direction of the vehicle. For example, when travelling at speed across the area of coverage provided by an access router, the time between handovers may be relatively short: if a vehicle is travelling at 70 mph across a cell of approximately 2 miles radius, the maximum time between handover may be of the order of about 100s. However, if the vehicle is travelling more slowly or if the vehicle is a bus with a twisting path through the area of coverage provided by the cell, the time between access router handover might be much longer. Accordingly the network operator will be able to configure the rules in PT 72 in the traffic flow controller 70 via the MPE 73 depending on the specific application where the MR 12 will be employed. It may also be possible for the MPE 73 to monitor and record time elapsed between network layer handovers of the MR 12 and to adjust the PT 72 accordingly. For example, if the MPE 73 detects that network layer handover is occurring every two or three minutes, the MPE 73 may adjust the PT 72 to route more data packet flows via the NEMOBT to preserve TCP connections and thereby the quality of service experienced by users. However, if the traffic flow controller detects network layer handover only every 30 minutes, the MPE 73 may adjust the PT 72 so that more packet data flows are routed via the RO routing method.

The PT 72 stores all traffic rules by which routing decisions are made by the MR 12. The traffic rules are stored in the electronic memory 71 in the form of a routing database 80 as shown in FIG. 10. The database 80 comprises four columns: a service description column 81, a traffic identifier column 82, a differentiation parameter 83 and a routing instructions column 84. Referring to FIG. 11, in this particular embodiment the service description column 81 is divided into the type of IP traffic, for example Web browsing traffic, Voice over IP (VoIP) traffic and all other traffic; the traffic identifier column is divided by host, for example by a care-of address configured by the VMN 14; the differentiation parameter column is divided by port number (i.e. an endpoint to a logical connection established by TCP for example), for example port 80 for Web browsing traffic, port 5004 for VoIP, etc.; the routing instructions column 84 details how the different types of traffic (as identified in the service description column) should be routed. In this particular PT, Web traffic on TCP port 80 from any host behind the MR 12 and VoIP traffic from interface 137.0.0.45 on TCP port 5004 is sent to the RO 74. All other traffic is sent via the ordinary NEMOBT. The MR 12 is configured to examine all data packets passing through the MR 12 and to examine the destination (or source) port number of the TCP segment therein. Each output port number is compared against the traffic identifier column of the PT 72. The rules in the PT 72 determine how the packet should be routed based on the destination port number. Once this has been determined, the packet is routed according to whichever rule is applicable to that packet.

The MPE 73 is responsible for configuring and implementing the traffic rules in the PT 72 and has network inputs 85 (FIG. 9), such as inputs from the MR 12 and/or home network of the MR 12, and user inputs 86 from the network operator and/or users. The MPE 73 may act dynamically to update the PT 72 in response to the inputs.

If the MPE 73 receives user inputs, it may operate as follows:

(1) the VMN 14 logs into the MR 12 after the user has boarded the train (the VMN 14 may do this automatically or the user may control login manually);

(2) the VMN 14 obtains an IP address in the subnet of the MR 12;

(3) via VMN 14 the user is offered choice of upgrading to better quality of service by payment of a fee;

(4) the user starts web browser on VMN 14 and logs into portal on MR 12;

(5) once payment is complete, MPE 73 is notified about the IP address assigned to the VMN 14 so that PT 72 can be updated to route optimise data packets originating from the VMN 14.

If the MPE 73 receives inputs from the MR 12, it may operate in one of the following ways:

### Scenario A

(1) first class customers may be given a premium account on the MR 12;

(2) details of all accounts are maintained in a database with a field for indicating whether or not the account is premium, a login name field, and an assigned IP address field;

(3) the VMN 14 logs into the MR 12 after the user has boarded the train (the VMN 14 may do this automatically or the user may control login manually);

(4) the VMN 14 obtains an IP address in the subnet of the MR 12;

(5) login name of user is used to search database to determine whether or not user has premium account;

(6) IP addresses are extracted from database for those accounts designated as premium;

(7) the MR 12 updates the MPE 73 with the extracted IP addresses such that data packets originating from any of the premium account holders will be route optimised.

### Scenario B

(1) the MR 12 monitors all traffic flows from the hosts on the train;

(2) MR 12 detects an increase in the number of TCP connections;

(3) MR 12 instructs MPE 73 to route optimise all Web traffic on TCP port 80 for example, to reduce encapsulation overhead and routing delays caused by the NEMOBT.

Under control of the PT 72, IP traffic passing through the MR 12 is either forwarded for ordinary NEMO routing or is forwarded the to RO 74. The RO 74 provides a route optimisation function for some or all of the IP traffic passing through the MR 12. In use, the RO 74 receives all traffic to be route optimized as directed by the PT 72.

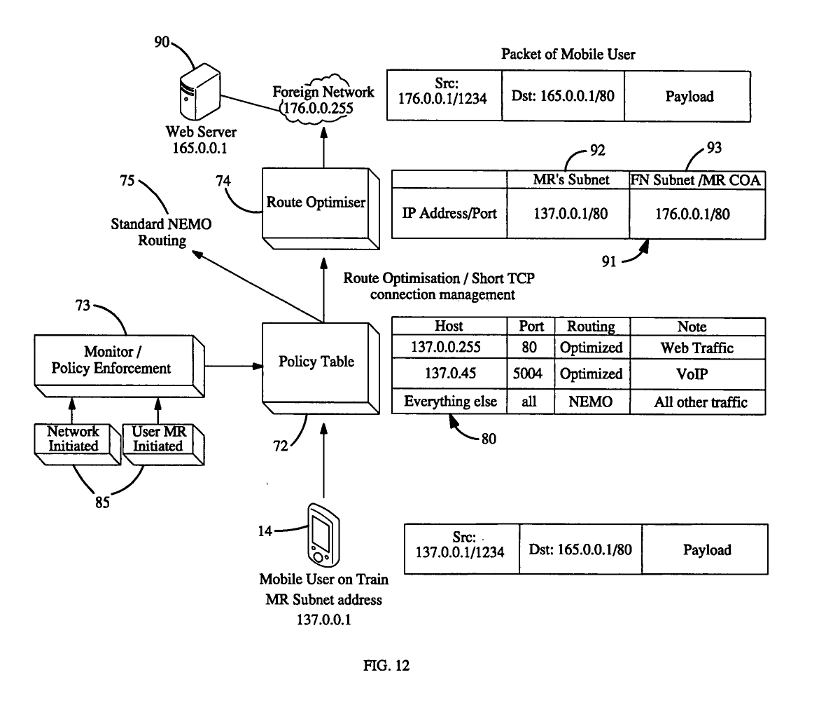

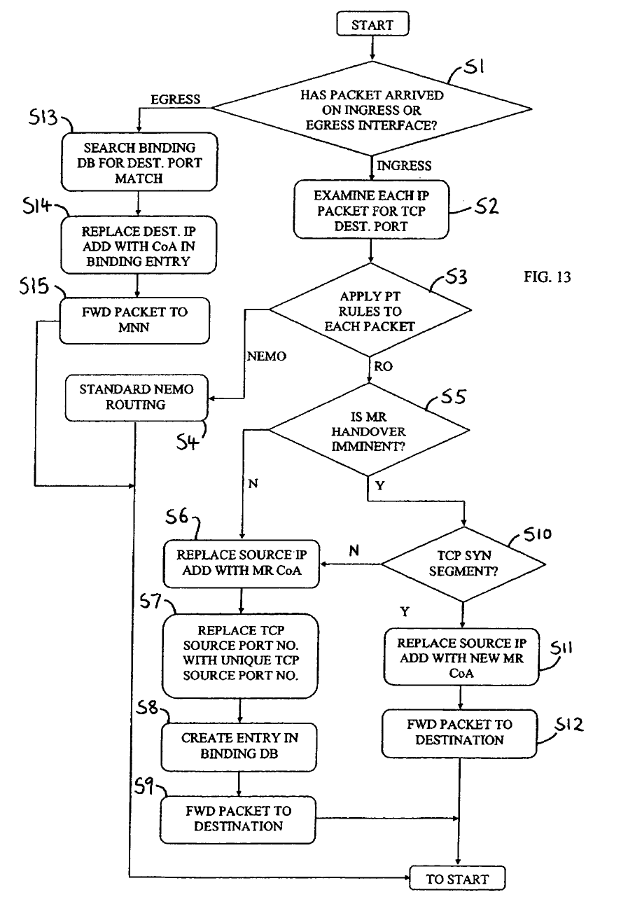

Referring to FIGS. 12 and 13 an example of the operation of the traffic flow controller 70 is shown from which the operation of the RO 74 will become clear. The VMN 14 arrives in the mobile network 10. As such it must configure a new care-of address, for example by combining the subnet of the MR 12 and the 64-bit Extended Unique Identifier (EUI) or MAC address of the VMN's network interface using stateless address auto configuration. Once the VMN 14 has completed all of the necessary binding update procedures with the HA_VMN, Return Routability test, etc. the VMN 14 is free to commence TCP connections from its new point of attachment in the network. To facilitate this, the MPE 73 should be configured by the network operator to enforce the necessary rules in the PT 72. For example, PT 72 may contain a rule that all traffic should be NEMO routed which has an IP header that is extended with the Mobility Header (MH) having a MH Type value of 1, 2 and 5 which indicates a Home Test Init Message, a Care-of Test Init Message and a Binding Update message (for further details see RFC 3775). Thus in scenarios (1)(a) and (1)(b) above the traffic flow controller 70 will ensure that mobility messages are handled by the more reliable routing method (i.e. the NEMOBT) before making any routing selection based on traffic type. Other rules may be implemented to route other flows of traffic as desired by the network operator.

For example, some VMNs may wish to operate under a secure transmission protocol, such as IPsec (see e.g. RFC 2401 and 2411). The RO 74 may or may not be useable with this type of traffic, depending on the level of security used. If the entire original IP packet is encrypted (as under one option of the ESP protocol for example), the route optimisation function of the invention cannot be used as the source IP address cannot be read by the RO 74, and therefore the rules of the PT 72 cannot be enforced. If the payload of the IP packet is encrypted, the RO 74 can determine whether or not that traffic is to be route optimised, but since the TCP/UDP segment header is encrypted it is not possible to change the source port number. If only the payload of the TCP/UDP segment is encrypted (or if a protocol such as the Authentication Header protocol is used where there is no encryption), then the traffic can be route optimized according to the invention.

The user of the VMN 14 starts a Web browsing application. The transport layer (e.g. TCP) goes about initialising a TCP connection with the CN 90 requested by the Web browsing application, in this case represented by the interface 165.0.0.1. The first TCP segment from the VMN 14 indicates a source port number of 1234, a destination port number of 80 (i.e. Web traffic) and has the SYN flag set to indicate that it wishes to initialise a TCP connection. The TCP segment is appended to an IP header having a source address of the care-of address of the interface on the VMN 14 (137.0.0.1) and a destination address of the CN 90 (165.0.0.1). The IP packet is passed down to the link layer and physical layer where it is transmitted to the MR 12 either directly or indirectly via other routers.

Referring also to FIG. 13, upon receipt of the data (or IP) packet at the MR 12, the traffic flow controller 70 applies the rules in the PT 72. In particular, at step S1 it determines whether or not the data packet arrived on the ingress or egress interface of the MR 12. For each data packet arriving on the ingress interface the traffic flow controller 70 determines which destination port is indicated in the TCP segment at step S2. At step S3, the traffic flow controller 70 determines which rule in the PT 72 applies to each data packet based on the destination port number. If a data packet is Web traffic or VoIP traffic it is forwarded to the RO 74. If the data packet does not fall into either of these classes it is sent at step S4 for standard NEMO routing using the NEMOBT. Since the IP packet from the VMN 14 is a Web browsing packet it is forwarded to the RO 74. The RO 74 comprises a binding database 91 having a VMN CoA/destination port field 92 and a foreign network/assigned port field 93. At step S5 the RO 74 interrogates the traffic flow controller 70 to determine whether or not a layer 3 handover is imminent or underway. If a “no” signal is returned, the RO 74 replaces at step S6 the source IP address of the IP packet (which is a public i.e. routable IP address) with a topologically correct IP address (which is also a public IP address) of an interface in the MR 12 on the network to which the MR 12 is currently attached (this will be the care-of address configured by the MR 12 for that interface when it attaches to that network during handover). At step S7 the RO 74 replaces the source port number in the TCP segment with an arbitrary port number that is not already used in the binding database 91. The RO 74 then makes a binding entry at step S8 in the binding database 91 which maps the field 92 to the field 93 for the VMN 14, which in this case will be:

| VMN CoA/port | FN/assigned port |
|---|---|
| 137.0.0.1/80 | 176.0.0.1/19876 |

Finally, the MR 12 forwards the amended IP packet (containing the amended TCP packet) toward the CN 90 at step S9. Since the source IP address has been changed to a topologically correct care-of address for the MR 12, the NEMOBT can be bypassed for this packet (and all other packets handled by the RO 74 for the VMN 14 in the same data packet flow). Thus the encapsulation and routing overhead are reduced for the VMN 14. Furthermore, By selecting a routing method based on expected TCP connection duration, those flows that are relatively short-lived can be routed by a first routing method that has a higher probability per unit time of connection interruption; whereas those TCP connections that are relatively long-lived can be sent by a second routing method that has a lower probability per unit time of connection interruption.

Upon receiving the IP packet, the application running on the CN 90 notes that the packet originated from interface 176.0.0.1 at port 19876 on the MR 12 and responds in the usual way, in this case with a SYNACK segment. The SYNACK segment will have a source port of 80 and a destination port of 19876. The SYNACK segment is encapsulated in an IP header in which the destination address is the interface of the MR 12 i.e. 176.0.0.1.

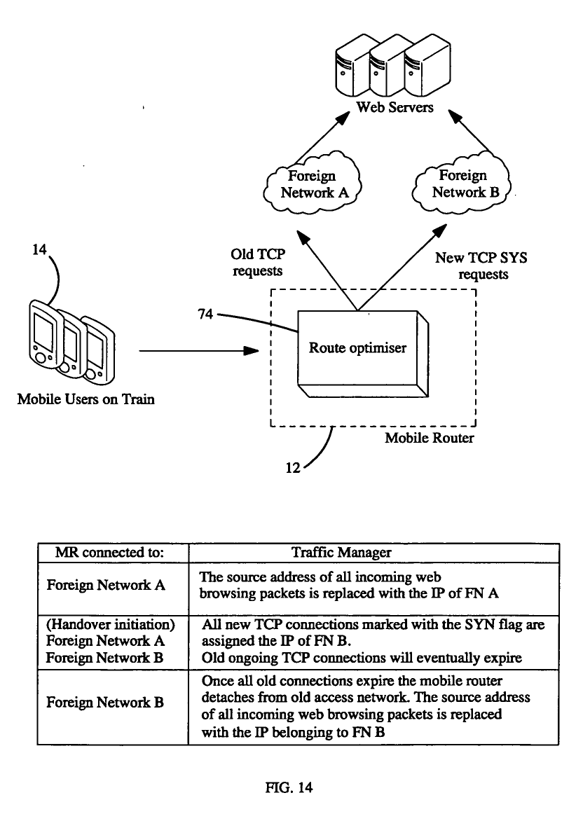

If at step S5, the traffic flow controller 70 indicates that handover is imminent or underway, the method proceeds to steps S10 to S12 described in greater detail below in conjunction with FIG. 14.

When the IP packet from the CN 90 arrives at the MR 12, step S1 of the method determines that the packet arrived on the egress interface. In that case the method proceeds to step S13 in which the RO 74 searches the field 93 of the mapping database 91 for a port number that matches the destination port number in the TCP SYNACK segment. If a match is found the RO 74 outputs the entry in the field 92 associated therewith i.e. the care-of address of the VMN 14 in the MR subnet and the source port assigned by the VMN 14. At step S14 the RO 74 changes the destination port number of the SYNACK segment to the source port number used by the VMN 14, and changes the destination IP address to the care-of address of the VMN 14. Finally the amended IP segment containing the amended TCP segment are forwarded to the VMN 14 on the MR subnet at step S15. Upon receiving the IP packet the process running on the network node believes that the TCP SYNACK segment was addressed to the correct port number and routed to the correct IP address. The RO 74 handles all further packets in the same way. The binding entry in the binding database 91 is maintained until the TCP connection is closed when the CN 90 sends a FIN segment.

Referring to FIG. 14 the MR 12 is shown in handover between two foreign networks: foreign network A and foreign network B. As mentioned above, the care-of address used by the RO 74 in the source address of IP packets is configured from a prefix advertised by the network to which it attaches. Accordingly during a handover, the MR 12 receives a new network prefix that it uses to configure a new care-of address. Use of the new care-of address by the RO 74 in ongoing TCP connections would cause termination of those connections and frustration for the users of VMNs since Web pages would appear unreachable until a “refresh” command is initiated. To avoid this problem the traffic flow controller 70 is provided with additional functionality as exemplified by steps S10 to S12 in FIG. 13. In particular, when the MR 12 receives a trigger (which might be a layer 3 trigger such as a Neighbour Unreachability Detection, or a layer 2 trigger such as a change in MAC address of the wireless interface of the access router), it may assume that a handover will follow shortly. Upon receiving the trigger the traffic flow controller 70 will respond with a “yes” signal when interrogated about handover by the RO 74 at step S5, and the MPE 73 enforces a temporary rule in the PT 72. In particular the PT 72 now also searches at step S10 for TCP segments in which the SYN flag is set i.e. an indication of a new TCP connection. If no SYN flag is detected the method proceeds to steps S6-S9 as described above. If the RO 74 detects a packet with the SYN flag set, the rule in the PT 72 forces the RO 74 to replace the source address of the IP packet at step S11 with the new care-of address configured from the network prefix advertised by foreign network B. At step S12 the packet is forwarded towards the CN. All TCP connections that are in existence and ongoing when the MPE 73 enforces the new rule in the PT 72 use the care-of address in foreign network A. Since the route optimising method is used for relatively short-lived TCP connections, the old TCP connections through foreign network A will expire relatively quickly. The PT 72 monitors all of the old TCP connections and, once they have all finished or expired, the MR 12 detaches from foreign network A. All incoming IP packets now have their source address replaced with the care-of address for an interface on the MR 12 in foreign network B, which is now the current care-of address such that RO proceeds using steps S6-S9. Steps S10-S12 are only used during and just before a layer 3 handover. In this way, the user of the VMN 14 is given the impression of substantially seamless service since packet loss is reduced and TCP connections are less likely to be interrupted.

Although the preferred embodiment of the invention has been described with reference to the TCP protocol, it will be appreciated that the invention is applicable to any other transport layer protocol e.g. User Datagram Protocol (UDP) or network layer protocol in which the type of application which generated the payload of the segment can be determined. If UDP is used it is to be noted that this is a connectionless protocol and thus no UDP “connection” can be said to exist. More appropriate is UDP “transmission” since all UDP data requests are sent regardless of the state of the receiving host.

Examples of mobile networks include, but are not limited to:

(a) networks attached to people (“Personal Area Networks” or PANs): a mobile phone with one cellular interface and one Bluetooth interface together with a Bluetooth-enabled PDA. The mobile phone is the MR while the PDA is used for web browsing or runs a personal web server;

(b) networks of sensors and computers deployed in vehicles; vehicles are provided with an increasing number of processing units for safety and ease of driving, as well as Internet access for passengers;

(c) access networks deployed in public transportation (buses, trains, taxis, aircraft, etc.): they provide Internet access to IP devices carried by passengers (e.g. laptop, camera, mobile phone representing host mobility within network mobility, or PANs i.e. network mobility within network mobility or “nested mobility”); and

(d) ad-hoc networks connected to the Internet via a MR: for example students in a train that need to set up an ad-hoc network amongst themselves and then enable the ad-hoc network with Internet access through the MR.

Mobile routers may be installed in a wide range of vehicles including private vehicles (e.g. cars, motorbikes), public transport and military vehicles (aircraft, tanks, lorries, boats, etc.)

Although the embodiment of the invention described with reference to the drawings comprises computer apparatus and methods performed in computer apparatus, the invention also extends to computer programs, particularly computer programs on or in a carrier, adapted for putting the invention into practice. The program may be in the form of source code, object code, a code intermediate source and object code such as in partially compiled form, or in any other form suitable for use in the implementation of the methods according to the invention. The carrier may be any entity or device capable of carrying the program. For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal that may be conveyed via electrical or optical cable or by radio or other means.

When the program is embodied in a signal that may be conveyed directly by a cable or other device or means, the carrier may be constituted by such cable or other device or means. Alternatively, the carrier may be an integrated circuit in which the program is embedded, the integrated circuit being adapted for performing, or for use in the performance of, the relevant methods.

While the invention has been particularly shown and described with reference to a particular embodiment, it will be appreciated that various of the above-disclosed and other features and functions, or alternatives thereof, may be desirably combined into many other different systems or applications. Also that various presently unforeseen and unanticipated alternatives, modifications, variations, or improvements therein may be subsequently made by those skilled in the art which are also intended to be encompassed by the following claims. Although the invention has been described with reference to specific preferred embodiments, it is not intended to be limited thereto, rather those having ordinary skill in the art will recognize that variations and modifications may be made therein which are within the spirit of the invention and within the scope of the claims.

What is claimed is:

1. A method of routing data packet flows from a mobile router in a mobile network, which mobile network comprises one or more network node attached to said mobile router, said mobile router for providing transparency at the network layer for said one or more network node to movement of said mobile network relative to a remote network infrastructure, which method comprises the steps of:
(a) receiving a data packet from a first host within said mobile network addressed to a second host;
(b) estimating which type of traffic is present in said data packet; and
(c) forwarding said data packet by applying a first routing method for a first type of traffic and a second routing method for a second type of traffic.

2. A method according to claim 1, wherein said first type of traffic comprises data generated by an application that typically requires a shorter duration of transport layer activity than said second type of traffic.

3. A method according to claim 2, wherein said duration of transport layer activity is defined with reference to a duration between network layer handovers of said mobile router, whereby said data packet is routed by said first routing method if said transport layer activity is expected to last less than said duration between network layer handovers or by said second routing method if said transport layer activity is expected to last longer than said duration between network layer handovers.

4. A method according to claim 1, further comprising the step of monitoring types of traffic flows through said mobile router and implementing said first and/or second routing methods depending on the relative proportions thereof.

5. A method according to claim 1, further comprising the step of selecting said first or second routing method based on a source network layer address in said data packet, whereby different users on said mobile network may be offered different levels of quality of service.

6. A method according to claim 1, further comprising the steps of storing a routing database in a memory of said mobile router, which routing database comprises a mapping between said first traffic type and said first routing method, and a mapping between said second traffic type and said second routing method, and searching said routing database when said traffic type has been estimated to determine the routing policy for said data packet.

7. A method according to claim 1, wherein said first routing method comprises a route optimized method in which said data packet can be sent toward said second host directly from the network to which the mobile router is attached.

8. A method according to claim 7, wherein said first routing method comprises the steps of replacing a source address of said data packet with a network layer address of an interface within a foreign network to which said mobile router is attached, whereby said data packet may be routed directly from said foreign network toward said second host.

9. A method according to claim 8, wherein said network layer address is different for each traffic flow passing through said mobile router.

10. A method according to claim 9, wherein said network layer address is the same for all traffic flows passing through said mobile router.

11. A method according to claim 7, further comprising the step of storing in electronic memory a unique identifier for each data packet flow, such that a return data packet flow sent from said second host in reply to said first host comprises said unique identifier, whereby said mobile router may forward said return data packet flow over the correct link toward said first host on said mobile network.

12. A method according to claim 11, further comprising the step of replacing an identifier of said traffic type in said data packet with said unique identifier.

13. A method according to claim 12, further comprising the step of storing a binding database in said electronic memory, which binding database comprises a mapping between an identity of said first host and said unique identifier, whereby data packets from said second host may be routed toward said first host.

14. A method according to claim 12, wherein said unique identifier comprises an arbitrarily assigned port number that has not already been assigned to another data packet flow passing through said mobile router.

15. A method according to claim 1, wherein step (b) comprises the step of examining said data packet for a traffic type identifier to identify said type of traffic carried therein.

16. A method according to claim 15, further comprising the step of examining a transport layer segment carried by said data packet to determine said type of traffic.

17. A method according to claim 18, wherein said traffic type identifier comprises a destination port number in a header of said transport layer segment, the method further comprising the step of using said destination port number to determine whether or not said data packet carries traffic of said first or second types.

18. A method according to claim 1, wherein said second routing method comprises the step of indirectly routing said data packet from said mobile router toward said second host, in which mobility of said mobile router at the network layer is substantially transparent to said first host.

19. A method according to claim 1, further comprising the step of monitoring the status of network layer handover of said mobile router and implementing a third routing method if and when said mobile router detects or is undergoing network layer handover between access routers.

20. A method according to claim 19, wherein said third routing method comprises the step of inspecting said data packet for an indication that said first host is attempting to establish a transport layer connection with or has just begun data transmission to said second host.

21. A method according to claim 20, wherein if said indication is present replacing a source address of said data packet with an address of an interface within a new foreign network to which said mobile router is to be handed over, whereby said data packet may be routed directly from said new foreign network toward said second host.

22. A method according to claim 20, further comprising the step of maintaining existing transport layer connections that are routed by said first routing method via the old foreign network during said handover.

23. A computer program comprising computer executable instructions for causing a mobile router to perform the method steps of:
(a) receiving a data packet from a first host within said mobile network addressed to a second host;
(b) estimating which type of traffic is present in said data packet; and
(c) forwarding said data packet by applying a first routing method for a first type of traffic and a second routing method for a second type of traffic.

24. A mobile router for use in a mobile network, which mobile network comprises one or more network node attached to said mobile router, said mobile router for providing transparency at the network layer for said one or more network node to movement of said mobile network relative to a fixed network infrastructure, which mobile router comprises an electronic memory storing computer executable instructions that when executed cause the mobile router to perform the method steps of:
(a) receiving a data packet from a first host within said mobile network addressed to a second host;
(b) estimating which type of traffic is present in said data packet; and
(c) forwarding said data packet by applying a first routing method for a first type of traffic and a second routing method for a second type of traffic.

25. A mobile network comprising a mobile router, which mobile network comprises one or more network node attached to said mobile router, said mobile router for providing transparency at the network layer for said one or more network node to movement of said mobile network relative to a fixed network infrastructure, which mobile router comprises an electronic memory storing computer executable instructions that when executed cause the mobile router to perform the method steps of:
(a) receiving a data packet from a first host within said mobile network addressed to a second host;
(b) estimating which type of traffic is present in said data packet; and
(c) forwarding said data packet by applying a first routing method for a first type of traffic and a second routing method for a second type of traffic.

26. A vehicle comprising a mobile router having an electronic memory storing computer executable instructions that when executed cause the mobile router to perform the method steps of:
(a) receiving a data packet from a first host within said mobile network addressed to a second host;
(b) estimating which type of traffic is present in said data packet; and
(c) forwarding said data packet by applying a first routing method for a first type of traffic and a second routing method for a second type of traffic.

27. A method of route optimizing data packet flows from a mobile network, which method comprises the steps of:
(a) receiving a data packet from a first host within said mobile network addressed to a second host;
(b) replacing a source address in said packet with a topologically correct address on a foreign network to which said mobile router is presently attached; and
(c) forwarding said packet toward said second host;
whereby data packets sent by said second host in reply will be addressed to said topologically correct address on said foreign network.

28. A method according to claim 27, wherein said source address is a public IP address and said topologically correct address is a public IP address.
